(19) United States
(12) Patent Application Publication
(10) Pub. No.: US 2007/0198442 A1
(43) Pub. Date: Aug. 23, 2007

(54) Sales method for mobile media

(75) Inventor: Stephen Taylor Horn, White Stone, VA (US)

Correspondence Address: Stephen T. Horn, 1661 James Wharf Road, White Stone, VA, 22578, US

(73) Assignee: Summerbrook Media Incorporated

(21) Appl. No.: 11/051,874

(22) Filed: Feb. 5, 2005

(51) Int. Cl. G06F 17/00

(52) U.S. Cl. 705/500

(57) ABSTRACT

The preferred invention is a method of sale of mobile media advertising where a bid system determines which entity gets to advertise at a specific time and location and direction of travel of the mobile media and said advertising is performed within a specific time and location and direction of travel. An example is a truck sign whose message can change dependent on time and or location and or direction of travel and the sale of this service is done by a web based bidding system.

### CROSS-REFERENCE TO RELATED APPLICATIONS

Horn et al applicant of this date titled “Mobile Information Display”

Horn applicant of this date titled “Controlling Customer Demand to Match Capacity”

Horn applicant of this date titled “Advertisement Comprehension in Mobile Media”

### FEDERALLY SPONSORED RESEARCH

None

### SEQUENCE LISTING

None

1. Field of the Invention

The field of this invention is in sales methods particularly to a dispersed and changing need in respect to time of day and location and direction of travel of an advertising message and the management of those factors in sales to maximize revenue.

2. Description of the Prior Art

There is little in the patent record concerning sales methods or management practices where time of day and or location are continuously changing variables along with direction of travel particularly with regard to a method of maximizing revenue.

### SUMMARY OF THE INVENTION

A service such as advertising on a sign where the message on the sign can change according to the particular location of the sign and the time of day, as for example a liquid crystal sign on a truck presents particular problems when considering a method of sale for this form of advertising. Typically an advertising bill board is sold by the month. But in the case of a mobile sign on a tractor trailer truck side or rear, the problems are multifaceted. If the billboard on the truck is sold by the month the advertisements must be generic and the product or service available over a broad area. But many products are not broadly distributed, certain businesses might be available in one state and not another. It is customary in some businesses to sell a particular territory or area for a service but this is not a solution either. Any truck sign in this particular territory would display a particular message. This unfortunately does not account for the different advertising messages that are appropriate at different times of day that the changeable format of a liquid crystal sign can accommodate. An advertisement for lunch at a restaurant is better done around twelve noon while a motel seeking lodgers would advertise around night time. Further, direction of travel is important in that if a customer is approaching a service he is more likely to be affected by advertising than if he is required to turn his vehicle around and go back to that service. This inconvienience would be particularly so on an interstate where exits are far apart. An example of a typical advertisement would be a banner sign on the back of a tractor trailer saying “Take your next exit for breakfast at McDonalds” This sign would then change as the truck sign passes the exit and the advertising potential changes. In this example the predetermination of the direction of travel of the sign is crucial. The direction of travel, not the location at any one time, is essential and it must be determined before the advertisement message is written. Location is necessary only to know when to start an advertisement. The direction of travel and location is later determined by the GPS and computer or otherwise once the advertisement has been loaded in the computer database and then needs to be displayed.

One of the objects of the present invention is to maximize the revenue of a mobile sign by accounting for both time and location and direction of travel of a potential customer and allow the market place to set the price for the advertising. The time and location and direction of travel of the customer is determined by the fact that to observe a rear facing advertising message a potential customer must be behind the truck and consequently his location direction and at what time is known. The market price for the advertisement is set by bid. The bid any customer places would be considered against the general cost advertising in other media and the prices others if they bid choose to bid and then chosen on this basis. The present invention also maximizes profit to the company buying the advertising by allowing it a communication means to change the message on the sign and by the ability to advertise only at the time a product is needed and only to potential customers traveling in the direction of the business. The communication means for an advertiser to change his sign could be through a computer web page to a cell phone equipped computer on a truck carrying the changeable sign. The present invention can allow the maximization of profit by breaking up locations into small cells and time into particular time intervals and determining direction of travel by cell or area sequence or other algorithm and allow a service to advertise by bid on both time and place after determining future consumer demand determined by his or her particular location, at a specific time and his or her direction of travel. That is at 8:00 am a traveler, traveling in the direction of a city; it can be assumed that a portion of the travelers are going to work and with this information future consumer demand can be determined. In this case, the consumer is not going to stop for anything that takes a long time because they are going to work. It is the unique ability of this invention to maximize revenue by establishing an immediate competitive bidding environment and by allowing a service to optimize its advertising by taking advantage of consumer location time and direction of travel variables, and accomplish this bidding in real time. The location cells and time increments can be described by the small sections and sold to maximize effectiveness at a particular advertising rate to a customer.

### BRIEF DESCRIPTION OF THE DRAWINGS

FIG. 1 is a diagram showing the interconnecting flow of information used within the preferred invention.

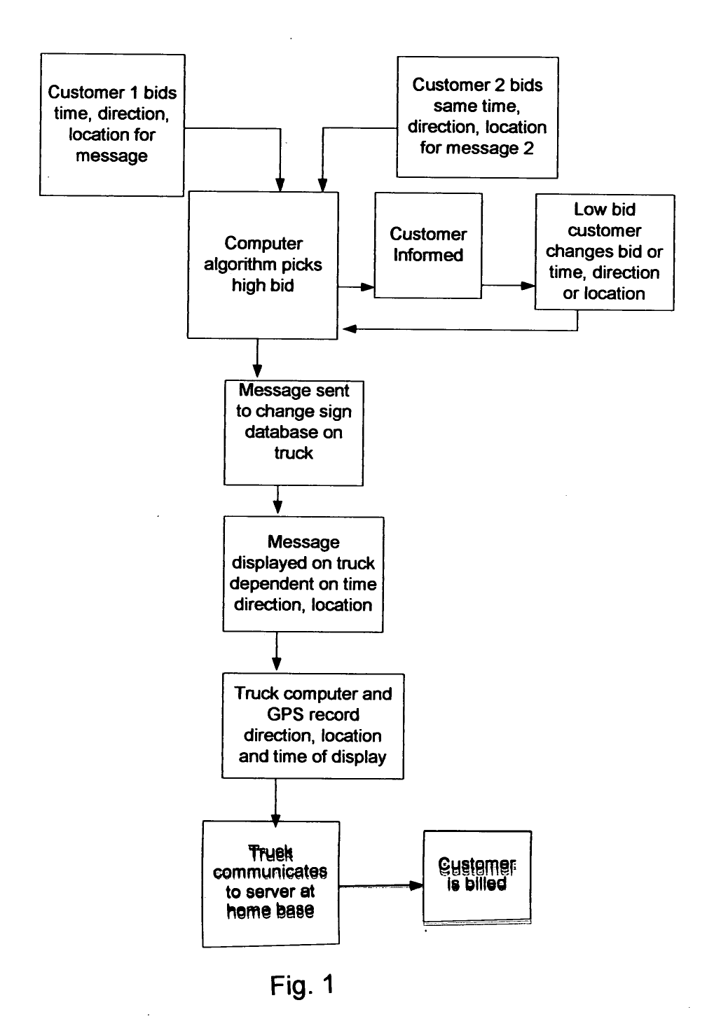

### DETAILED DESCRIPTION OF THE PREFERRED EMBODIMENT(s)

The sales method of the present invention would work in the following manner for the preferred embodiment. The sales method is actually granting a right to a customer for presenting an advertising message because unlike a sale of other forms of advertising. The customer may or may not pay anything determined by whether a truck displaying the customers advertisement actually passes a location in a direction they have requested. If this does not occur they are not billed but yet they have the rights to that location direction and time. In the preferred embodiment it would be a bid system for this right or lease. Customer number one as for example a McDonald's restaurant would go to a web page and seek a particular location of their restaurant on a map provided on the web page or alternatively enter a location by address or coordinates. They would then choose a time and direction of travel such as “north bound” and place a bid as for example $0.15 and enter an advertisement suitable for display on a truck banner. Such advertisement would be designed to take advantage of the time, the location, and direction of travel of the potential customer following the truck and able to read the banner. Such a bid could be for a number of locations and could have a limit on the amount to be spent. Such a bid could be for a general location where the specific location is unknown at the present but will be known later. An example would be bidding on a general location of a snow storm as it moves to sell snow tires. The bids would be for a general area around the center of the storm and where they were not out bid by stationary locations; they would prevail.

Bids could contain a formula that would scale the bid in accordance to the time of day and the location. Thus the bid would rise as the truck sign approaches an optimal location and time and decline after that. Customer number two as for example a Shell gasoline station occupying an adjacent corner to the McDonalds could also bid on the same time and location through the web page. At a certain time bids could be closed or could be held open as bids are accepted by the server. A central processor or computer would use an algorithm to determine which bid would be accepted. Typically the high bid would be accepted. The Shell gasoline station would in most instances bid higher at night time than the McDonalds and conversely the McDonalds would typically bid higher during the lunch time hours. Either company once they lease the time and place for the display of advertising could change the message of the advertisement for a time during the lease period. Both McDonald's and Shell would favor the same direction of travel and optimal location for the advertising to begin but their time requirements would be different and thus their bids for these times would also be different. The processor or computer would notify the customer either by email or otherwise that their bid was accepted or rejected at which time they could alter their bid or their location or their direction of travel or their time. Payment could be by credit card or any other means that gave value to the advertising company. The advertisement of the winning bidder would be sent to the truck signs on the back of the trucks via a cell phone connection or something similar. The message would then be displayed on the rear of the truck according to the time and location and direction of travel of the truck. This would be accomplished by a processor or computer and a database of advertisements and their corresponding times and locations and directions of travel. Once the truck sign passes a location and displays the advertisement, the computer on board would record the time and the location and direction and the message displayed and forward that through the cell phone or other connection to the home base server and the customer would then be billed according to the rule set established.

When referring to a truck sign or liquid crystal sign this should not be interpreted to exclude signs such that might be changed by other means or operated by other means. Thus a light emitting diode sign on a truck that changed according to location and time and direction of travel would be covered in this patent. Direction of travel could be described both by a compass direction or relative direction to a known place or by computing a vector by sequential locations or by following an entity whose direction is known or by inertial reference to a known direction or any other method to determine direction from one point to another. Direction of travel must be determined before any message can be written. Direction of travel can be toward more than one business as businesses close to each other are in the same direction of travel on a road. Side of vehicle refers to front, back, left or right side of a vehicle. Time and location can be divided into small parts or can have larger boundaries. Location refers to geographical location but general location can be a future location as yet determined an example being the general location of a thunder storm. The specific location of the storm center is unknown and any central absolute location is never known. Thus a general location in this case of the storm is specified. Location can also be at a moment in time as when the mobile sign passes through a location but does not stop. This moment is small and yet can be a part of the description of location of a moving target which the sign is. This moment of time should not be confused with time of day which is a measurement with beginning and end. But the location that is most often sold to a customer is an area and all the points within that area. Location in this case is an area measured from an idealized point that is probably defined by a certain distance from a fixed point such as an exit on a highway. A computer or processor or server is a machine that can along with their normal definition apply an algorithm or set of rules to data and act on the results. A bid could be given in a monetary amount or in a formula or in ratio to indicate value. Information is communicated by cell phone or pager or electronically within the system in code or otherwise. A service with regard to the company selling advertising could be an advertisement or right to advertise or message displayed or conveyed in any manner. A service with regard to a company buying advertising is anything a customer would pay for. A customer is anyone or entity that potentially may purchase something. They or a purchaser may be identified by name or by code or by password or symbol. Mobile media is any message delivering system that moves from location to location over time. To lease means to gain the use of a tangible or intangible asset for a finite length of time. A lease gives certain rights. An undetermined number of mobile signs could be zero or one or more signs. To present a message is to show a message or display a message. A business can lease a stretch of roadway from the advertising business that will provide advertisement services such as advertising on mobile trucks but this should not restrict otherwise the use of the roadway or imply the physical leasing of the roadway itself. The stretch of roadway merely defines the place where the advertising message will be displayed. The direction of travel can be defined on the map such as North bound or by reference to another direction or by compass heading in the sale of the advertising. The preceding descriptions should not be considered limiting but rather to clarify and give example.

Further objects and advantages of my invention will become apparent from a consideration of the drawings and or ensuing description. There are a number of issues in this invention that are interrelated with one another. Some of this has been discussed but should be restated. There is the issue of direction of travel of both the display with the message on it relative to both a business and other vehicles. The content of the message is determined not only by its location but also by the direction of its travel whether toward a particular exit or business or away. The content of a message is determined by the local time of day whether it might be breakfast time or late at night. The content of a message is determined by the demand cycle of a product. This refers to a product or service that has a particular time span before it is needed again. An example is a hamburger can be desired every few hours but mostly at lunch while a new car is desired every few years or a soft drink could be desired every hour and an oil change every few months. The present invention is distinctly able to accommodate combinations of product demand cycles in conjunction with direction and time. The time a message is exhibited on a display and text size and length is dependent on the above and the relative speed of an observer. All of these considerations must be formed around anticipated potential customers that are determined by their location and direction of travel at a particular time of day. A customer traveling in the direction of a scheduled rock concert at a particular time of day is an anticipated potential customer for a particular service while the same person at a different time of day or traveling in a different direction or location is not. The anticipated location of a message on a plurality of mobile display units must account for this as well as all the above. Only some of the LCD displays on some of the trucks in this example would be selected to carry a message and these units would direct traffic in this case to the rock concert, according to the multiple algorithms suggested above. The present invention is multifaceted and should not be limited without consideration of these factors.

It is intended that further embodiments incorporating the spirit of the invention to one skilled in the art, fall within the scope of this invention.

I claim:

1) A method of granting rights to a customer to present a customer's message on an undetermined number of mobile sins, said method comprising:
a) determining said customer's message;
b) determining customer specified criteria under which said message shall be presented;
c) determining a price agreed to by said customer for said rights;
d) granting said rights to said customer for said price for each mobile sign displaying said customer's message meeting said customer specified criteria.

2) The method of claim 1 wherein said customer specified criteria is location and direction of travel of said sign.

3) The method of claim 1 wherein said customer specified criteria is location of said sign is an area and time of day.

4) The method of claim 1 wherein said customer specified criteria is an algorithm.

5) The method of claim 1 wherein said customer specified criteria is a location and a time of day and further agreeing that said message may possibly not be presented.

6.) A method of purchasing by a purchasing entity advertising on mobile signs said method comprising:
a. Identifying said purchasing entity,
b. Selecting location by said purchasing entity for advertisement,
c. Selecting direction by said purchasing entity for said advertisement,
d. Placing bid by said purchasing entity for said advertisement on said location, on said direction,
e. Placing subsequent highest bid by said purchasing entity for same said advertisement on same said location, on same said direction upon bidding ending, thus purchasing advertising on said mobile signs.

7) The method of claim 6 said claim further comprising: where a location is an area.

8) A method of purchasing by a purchasing entity advertising on mobile signs said method comprising:
a. Identifying said purchasing entity,
b. Selecting location by said purchasing entity for advertisement,
d. Selecting direction by said purchasing entity for said advertisement,
f. Paying money by said purchasing entity for said advertisement on said location, on said direction, thus purchasing advertising on mobile signs

9) The method of claim 8 said claim further comprising: where a location is an area.

10) A method of sale of advertising on mobile signs said method comprising:
a. Bidding by a first customer a first customer's amount of money to lease said mobile sign at a location,
b. Bidding by a subsequent customer a subsequent customer's amount of money to lease same said mobile sign at a location,
c. Informing all customers of bid where each may place another bid on same said mobile sign at same said location,
d. Choosing said customer at end of bidding
e. Granting a lease to said chosen customer for same said location, on said mobile sign for chosen customer's amount of money thus selling mobile sign advertising.

11) The method of claim 10 said claim further comprising: bidding for a time of day and granting said lease for said time of day.

12) The method of claim 10 said claim further comprising: where bids are placed on a web page.

13) The method of claim 10 said claim further comprising: where choosing said customer is done with an algorithm

14) The method of claim 10 said claim further comprising: where a lease is the granting of rights

15) The method of claim 10 said claim further comprising: where a location is an area.

16) The method of claim 10 said claim further comprising: bidding for a direction of travel and granting said lease for direction of travel and informing where each may place another bid on same said mobile sign at same said location and direction of travel,

17) A method of sale of advertising on mobile signs said method comprising:
a. Bidding by a first customer a first customer's amount of money to lease said mobile sign at a location,
b. Bidding by a subsequent customer a subsequent customer's amount of money to lease same said mobile sign at a location,
c. Choosing customer
e. Granting a lease to said chosen customer for same said location, for said mobile sign for chosen customer's amount of money thus selling mobile sign advertising.

18) The method of claim 17 said claim further comprising: bidding for a time of day and granting said lease for said time of day.

19) The method of claim 17 said claim further comprising: where bids are placed on a web page.

20) The method of claim 17 said claim further comprising: where choosing said customer is done with an algorithm.

21) The method of claim 17 said claim further comprising: where a lease is the granting of rights.

22) The method of claim 17 said claim further comprising: where a location is an area.

23) The method of claim 17 said claim further comprising: bidding for a direction of travel and granting said lease for said direction of travel.

24) A method of sale of advertising on mobile signs said method comprising:
a. Bidding by a customer an amount of money to lease said mobile sign at a location,
b. Granting a lease to said customer for same said location, thus selling mobile sign advertising.

25) The method of claim 24 said claim further comprising: bidding for a time of day and granting said lease for said time of day.

26) The method of claim 24 said claim further comprising: where bids are placed on a web page.

27) The method of claim 24 said claim further comprising: where a lease is the granting of rights

28) The method of claim 24 said claim further comprising: where a location is an area

29) An apparatus for purchasing advertising on a mobile signs comprising: A means of communicating identity of lessee, and location for said advertising message to be displayed, and monetary amount to be paid for said mobile sign to be displayed, to a mobile sign leasing business

30) An apparatus as in claim 29 further comprising: where the means of communicating is through a computer.

31) An apparatus as in claim 29 further comprising: where the means of identity of lessee is a password.

32) An apparatus as in claim 29 further comprising: where location is a general area

33) An apparatus as in claim 29 further comprising: where the means of communicating is through a web page.
